(19) United States
(12) Patent Application Publication
(10) Pub. No.: US 2026/0069501 A1
(43) Pub. Date: Mar. 12, 2026

(54) PAPER BOTTLE SYSTEM FOR PHARMACEUTICALS

(71) Applicant: Robert T. Wheeler, Wapekoneta, OH (US)

(72) Inventor: Robert T. Wheeler, Wapekoneta, OH (US)

(21) Appl. No.: 18/884,078

(22) Filed: Sep. 12, 2024

Related U.S. Application Data
(60) Provisional application No. 63/526,573, filed on Jul. 13, 2023.

(51) Int. Cl. A61J 1/14; A61J 1/03; B65D 3/06; B65D 23/02; B65D 65/46

(52) U.S. Cl. CPC A61J 1/1468; A61J 1/03; A61J 1/1418; B65D 3/06; B65D 23/02; B65D 65/466

(57) ABSTRACT

A paper bottle system for pharmaceuticals is disclosed. The system includes a first frustum-shaped conical section formed of heavy-weight paper, a second frustum-shaped conical section formed of a biodegradable material, a biodegradable lid, and an aqueous coating. The conical sections are angled between 5-8 degrees from vertical, allowing for efficient nesting and stacking. The system is designed to be environmentally friendly, easily recyclable, and optimized for short-term use. When disposed of in a landfill, the paper bottle system quickly breaks down, contributing to soil health and reducing environmental impact.

### CROSS-REFERENCE TO RELATED APPLICATIONS

This application claims priority under 35 USC 119(e) to provisional application 63/526,573, filed on Jul. 13, 2023 to Todd Wheeler for the invention entitled: “A paper bottle for over the counter and prescription pills that is optimized for short-term use.”

### FIELD OF THE INVENTION

The technical field of this invention relates to pharmaceutical packaging, specifically biodegradable and recyclable containers for storing and dispensing medications. The invention particularly concerns paper-based bottles designed for short-term use in storing and dispensing pills or other pharmaceutical products. This field encompasses sustainable and environmentally-friendly alternatives to traditional plastic medication containers.

### BACKGROUND OF THE INVENTION

Since the mid 1700s, bottles for medicine or pills were typically made from blown glass and fitted with a cork stopper. These were the only materials available at the time which could permit sealing of the bottle and viewing inside the bottle to simply indicate if any medication was left. Issues such as bottle shipping and recyclability were not even a consideration during that age and time.

Starting in about the 1930s, inexpensively produced plastics were manufactured for the first time as medicinal bottles, with caps for the bottles formed from synthetic, flexible plastics such as polyurethane and polypropylene. However, these bottles had to be packed side by side in large shipping boxes, since they could not be individually stacked and additionally consumed large amounts of floor space in the relatively small pharmacies that were typical of that era. With worldwide usage of plastic bottles and caps which could potentially remain intact for hundreds of years, recyclability started to become a serious environmental issue, as landfills throughout the world began to overflow with plastics that could remain intact for centuries.

### SUMMARY OF THE INVENTION

The current invention outlines a novel paper medication bottle which is provided which can be composted, recycled or sent to a landfill with minimal impact to the land, wildlife and underlying water table. The crush resistance of a cylindrical paper medication bottle is lower than that of a plastic pill bottle, and therefore, it can be compacted more easily and reduce landfill volume.

The paper medication bottle is made from sustainable paper and a biodegradable ingredient such as cornstarch. The paper medication bottle additionally receives an aqueous inner and/or outer coating which improves the performance of the container without introducing a layer of polyethylene plastic, as conventional paper cups do. When disposed of in a landfill, the paper medication bottle quickly breaks down, contributes to moisture retention in the soil, and can help aerate soil and contribute to the health of biological ecosystems.

The claimed invention recites novel differences from the currently known prior art. A paper bottle joined to a compostable receiver optimizes the strengths of discrete materials to create a container that is a strong and sustainable alternative to plastic. Unlike the cylindrical shape of plastic bottles, the paper bottle features angled walls to permit the bottles to be nested for efficient and more cost-effective shipping to medication providers. No existing medication bottles are as rapidly biodegradable, while providing this level of shipping efficiency.

Additionally, the bottle is frustum shaped with an open top. This allows for space efficient stacking of the bottles to reduce the size of their corresponding shipping packages. This differs from the current practice of packing rigid plastic or glass bottles side-by-side in a large shipping container, thus reducing both shipping costs per bottle and storage space at the end distributor or pharmacy.

### BRIEF DESCRIPTION OF THE DRAWINGS

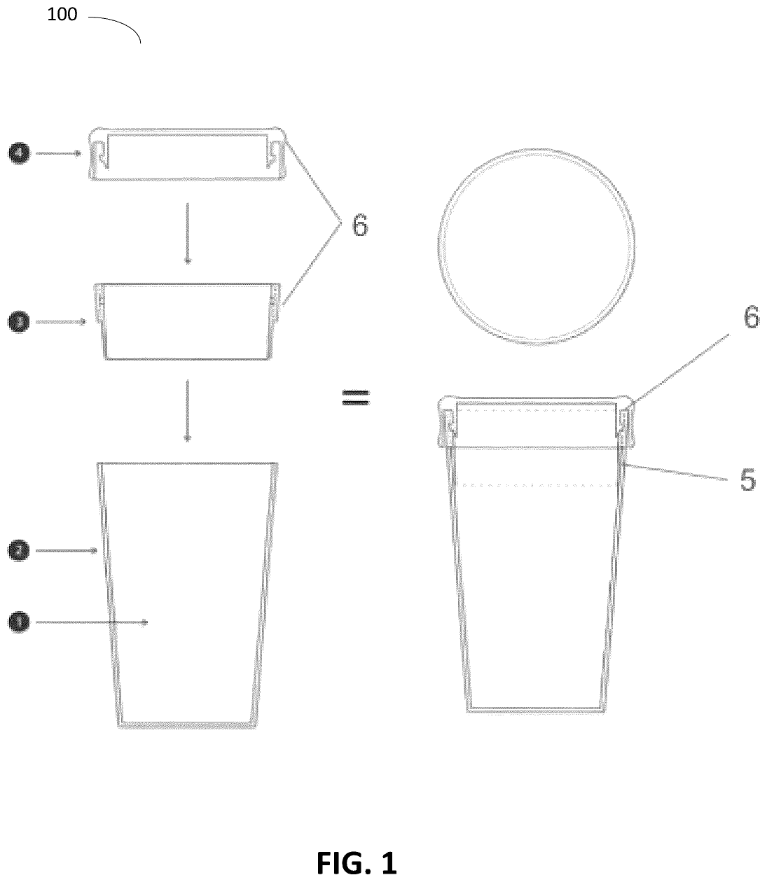

The features and advantages of aspects of the present invention will become more apparent from the detailed description set forth below when taken in conjunction with the claims and drawings, in which like reference numbers indicate identical or functionally similar elements. FIG. 1 illustrates the paper bottle and its components as a preferred embodiment of the invention.

### DETAILED DESCRIPTION OF THE INVENTION

In the following description, numerous specific details are set forth to clearly describe the embodiments disclosed herein. One skilled in the art may understand that some well known features have not been described in detail so as not to obscure the invention. Reference is made herein to the attached drawings. Like reference numerals may be used in the drawings to indicate like or similar elements of the description. The figures are intended for representative purposes and should not be considered limiting.

The present disclosure can be understood more readily by reference to the following detailed description of the present disclosure and the examples included therein. Before the present articles, systems, devices, and/or methods are disclosed and described, it is to be understood that they are not limited to specific implementations unless otherwise specified, or to particular approaches unless otherwise specified, as such can, of course, vary. It is also to be understood that the terminology used herein is for the purpose of describing aspects only and is not intended to be limiting. Although any methods and materials similar or equivalent to those described herein can be used in the practice or testing of the present disclosure, example methods and materials are now described.

All publications mentioned herein are incorporated herein by reference to disclose and describe the methods and/or materials in connection with which the publications are cited.

### Definitions

It is to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this present disclosure belongs. In this specification and in the claims which follow, reference will be made to a number of terms which shall be defined herein.

As used in the specification and the appended claims, the singular forms “a,” “an,” and “the” include plural referents unless the context clearly dictates otherwise. Thus, for example, reference to “an opening” can include two or more openings. Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise. As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of aspects described in the specification.

Disclosed are the components to be used to manufacture the disclosed devices, systems, and articles of the present disclosure as well as the devices themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the present disclosure. Thus, if there are a variety of additional steps that can be performed it is understood that each of these additional steps can be performed with any specific aspect or combination of aspects of the methods of the present disclosure.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

In a preferred embodiment of the invention, a sustainable medication bottle made from easily recycled or compostable materials is a secure and sustainable alternative to plastic as a short-term container for medication. Made primarily from paper, the paper bottles feature a conical shape which permits them to be nested together for more efficient bulk shipment to medication providers.

The use of plastic to fabricate medicine containers would be a non-issue if they enjoyed a 100 percent recycling rate. However, the ubiquity of plastics that go directly into landfills is growing and not shrinking. Existing plastic medication bottles are made primarily of polypropylene which possesses a quantifiable amount of toxicity to humans. Scientific data on the impact of microplastics in the human body point to some interference in biological processes, while increased use of paper bottles will reduce this variable in biological systems.

The paper medication bottles of the preferred embodiment are made from sustainable paper combined with a biodegradable ingredient such as cornstarch. The paper medication bottle receives an aqueous coating on the inner and/or outer surfaces which improves the performance of the container without introducing a layer of polyethylene plastic, as conventional paper cups do. If disposed of in a landfill, the paper medication bottle will quickly break down, contribute to moisture retention in the soil, and can help aerate soil and contribute to the health of biological ecosystems. Within the scope of the preferred embodiments, the invention may also encompass bottles or containers manufactured for non-medication uses, wherever a small form factor of sustainable bottles or containers may be of use.

In reference to FIG. 1, FIG. 1 illustrates the four components of the paper bottle 1 as follows: Reference numeral 2 refers to an aqueous coating on a paper bottle 1 to control paper permeability. Reference numeral 1 indicates a heavy weight paper frustum 1 (truncated cone). Reference numeral 3 indicates a biodegradable bottle receiver 3 formed from a biodegradable material, preferably related to or the same as the material used to form the paper frustum 1. The bottle receiver 3 is friction fitted and adhesively joined to said paper frustum 1. Reference numeral 4 indicates a bottle lid, also formed from a biodegradable material, preferably related to or the same as the material used to form the paper frustum 1.

In the preferred embodiments of the invention the paper frustum 1 and/or the bottle receiver 3 are sprayed with an aqueous coating 2 at least on their inner surfaces. Additionally, it is contemplated that the paper frustum 1 and bottle receiver 3 are sprayed on all surfaces, within the scope of the present invention.

Conventionally manufactured paper is sourced to provide the primary material used in fabricating the frustum 1. One to two layers of heavy weight paper are die cut and joined together forming a paper frustum 1. The paper frustum 1 is glued to the bottle receiver 3, and the bottle lid 4 is manually applied after the bottle is filled with medication. The result is a medication container fabricated in the shape of the frustum of a cone made of multiple layers of heavy weight paper 1 terminating in a receiver 3 made of more durable, biodegradable material. Paper cup manufacturing processes are employed, with novel considerations made for the small size (base diameter of less than two inches) and the resistance of the cup to unsupervised access by children. For example, child resistance of the cup may be achieved by deploying a screw locked 6 lid 4 that is attached to an appropriately threaded bottle. Successful container integrity is achieved by forming the frustum 1 of multiple layers of heavy weight paper, orienting paper grain in an advantageous direction, optimally sizing the circumference and chemically bonding the frustum 1 to the receiver 3 as shown in 5. The receiver 3 is angled to the same 5 to 8 degrees of the paper frustum 1, and the receiver 3 and frustum 1 are subsequently joined together 5. Nesting of fully fabricated bottles 5 attached to receivers 3 is facilitated by a nominal increase in the diameter of the receiver 3 dimensions beyond the size of paper wall thickness. This invention achieves torsional stability, as well as high crush resistance, by the joining of the angled receiver 3 to an optimized paper wall 1 and surface area ratio making it durable over the life of the container. Once combined, these elements work in concert to ensure that the container possesses a strong enclosure while maintaining ease of use for age appropriate access.

The angle of the frustum 1 is carried through to the receiver 3, and the receiver 3 extends a small distance past the planes of the inside and outside of the paper wall thickness. This permits the nesting of paper bottles 1 for more efficient shipping. The lid 4 joins with the receiver 3 from the inside, which prevents a compression force on the outside of the bottle that could separate the bottle 1 from the lid 4 and expose the medical contents. The lid 4 may securely connect to the receiver 3 through a standard bayonet mount 6, unless the threaded child resistant packaging is used. The angle of the paper bottle 1 sides, according to the preferred embodiment, fall between 5 and 8 degrees to facilitate ease of separation in a nested state for shipping. The paper layers provide structural integrity to withstand as many open and close operations to support access to the enclosed medication, or about 300 operations per bottle.

The lid 4 and receiver 3 may be made from adequately sized biodegradable or compostable material, and it imparts strength onto the opening of the paper walled frustum 1. A floor, or bottom, made of the same heavy weight paper of the frustum 1 or of the biodegradable or compostable material imparts strength upon the bottom opening of the paper walled frustum 1. The bottle is a unified whole which provides a careful blending of material to achieve structural integrity yet still be manufactured out of sustainable material.

In use, the paper bottle 5 is held firmly in one hand, while the lid 4 is connected and disconnected with the other hand using a twist motion. The lid 4 may be tightened by right-handed turning and loosened by left-handed turning, or vice versa. The paper bottle 5 can be fitted with child resistant threaded lids or adult use non-threaded lids. In either instance, rigidity of the paper bottle 5 is essential for the bottle 5 to perform its primary function of securely containing its contents.

In accordance with the invention, a paper bottle system for pharmaceuticals may comprise: a first frustum shape conical section formed essentially of heavy-weight paper, said conical section having a flat enclosed bottom section and an open top section;
a second frustum shaped conical section fitted within the upper inside surface of said first conical section, said second conical section formed essentially of a biodegradable material, said second conical section being open at both an upper end section and a lower end section;
a lid for sealing the top section of said second conical section formed from a biodegradable material and shaped to form an enclosed container;
an aqueous solution coated on at least the inner surfaces of said first conical section and said second conical section.

The angle of said first conical section and said second conical section may be angled between 5-8 degrees from vertical. This angled configuration may facilitate nesting of multiple bottles for efficient shipping and storage.

In some embodiments, said first conical section and said second conical section may be friction fitted together. Alternatively or additionally, said first conical section and said second conical section may be adhesively joined together to provide a secure connection.

The second conical section may be formed from a heavier weight biodegradable material than said first conical section in some implementations. This may provide additional strength and durability to the bottle opening.

The lid may be friction fitted to said paper bottle in some embodiments. Alternatively, the lid may be screw locked to said bottle to provide child-resistant functionality.

In a preferred embodiment, the second conical section may be formed essentially of cornstarch or another biodegradable material. The aqueous solution may be coated on the inner surfaces and/or outer surfaces of said first conical section and said second conical section.

The paper bottle system achieves torsional stability and crush resistance through the joining of the angled receiver to an optimized paper wall and surface area ratio, making it durable over the life of the container while still being biodegradable. The bottle may be configured to withstand approximately 300 open and close operations to support access to enclosed medication.

When disposed of, the paper medication bottle may quickly break down, contributing to moisture retention in soil and aiding in soil aeration to promote environmental health. This provides an eco-friendly alternative to conventional plastic medication bottles.

### Methods of Use

Methods of use for the paper bottle system for pharmaceuticals may be described as follows:

The pharmacist or medication provider may fill the paper bottle by holding the assembled paper frustum and bottle receiver securely. The medication may be poured or placed into the open top of the bottle. Care may be taken to ensure the medication does not exceed any fill line that may be present. After filling, the pharmacist may seal the bottle by aligning the lid with the top opening of the bottle receiver. The lid may be pressed down firmly to friction-fit it in place. Alternatively, if using a child-resistant threaded design, the lid may be screwed clockwise onto the bottle. The pharmacist may check that the lid is securely fastened.

The pharmacist may apply necessary labeling by affixing a printed label to the outer surface of the paper frustum. All required information may be ensured to be clearly visible. Care may be taken to avoid covering any safety or usage instructions that may be molded into the bottle. Multiple filled bottles may be efficiently stored or shipped by gently inserting the bottom of one bottle into the top opening of another. This stacking or nesting process may continue until reaching the desired height or quantity. The pharmacist may ensure the stack remains stable and secure.

When dispensing the medication, the pharmacist may carefully remove a single bottle from the nested stack. The contents and label information may be verified. Any additional usage instructions may be provided to the patient at this time. The patient may access their medication by holding the bottle firmly in one hand. The other hand may be used to open the lid. For friction-fit lids, this may involve grasping and pulling upward. For child-resistant lids, the patient may press down while turning counterclockwise. The prescribed dose of medication may then be removed. After use, the bottle may be resealed securely.

After the medication course is complete, the patient may dispose of the bottle by removing any remaining medication as instructed by their pharmacist. The empty bottle may be placed in a recycling bin designated for paper products. Alternatively, it may be disposed of in a regular trash bin, with the knowledge that it will biodegrade quickly.

Facilities equipped to handle medical waste may collect used paper bottles for recycling. The bottles may be sorted based on material composition. The paper components may be processed for recycling, while biodegradable components like the cornstarch receiver may be composted. If the bottle ends up in a landfill, it may absorb moisture from the surrounding environment. The bottle may begin to break down relatively quickly compared to plastic bottles. As it decomposes, it may contribute to soil aeration and moisture retention.

The paper bottle system may include alternative structures or implementations to enhance its functionality and environmental benefits. Some potential alternatives include:
1. Variable wall thickness: The paper frustum may be designed with a gradient wall thickness, being thicker at the base and thinner towards the top. This could provide additional stability while reducing material usage.
2. Reinforced bottom: The flat enclosed bottom section may be reinforced with additional layers of heavy-weight paper or biodegradable material to improve crush resistance when stacked.
3. Textured exterior: The outer surface of the paper frustum may feature a textured pattern to enhance grip and reduce slippage during handling.
4. Tamper-evident seal: An additional biodegradable tamper-evident seal may be incorporated between the lid and the bottle receiver to improve security.
5. Multi-chamber design: The interior of the bottle may be divided into multiple chambers using biodegradable dividers, allowing for storage of different medications or dosages within a single container.
6. Moisture-absorbing liner: A thin, biodegradable moisture-absorbing liner may be added to the interior to help protect moisture-sensitive medications.
7. Printed dosage information: The exterior of the paper frustum may feature printed dosage instructions or medication information using biodegradable inks.
8. Color-coding system: Different colors of paper or biodegradable dyes may be used to create a color-coding system for easy identification of different medications or dosages.
9. Biodegradable window: A small, transparent biodegradable window may be incorporated into the paper frustum to allow visual inspection of the contents without opening the container.
10. Stackable lid design: The lid may feature a recessed top surface that corresponds to the shape of the bottle's base, allowing for more secure stacking of filled containers.

These alternative structures or implementations may provide technical advantages such as:
1. Improved stability and durability while maintaining biodegradability
2. Enhanced user experience through better grip and ease of identification
3. Increased medication safety through tamper-evident features and moisture protection
4. Greater versatility in medication storage and dispensing
5. Reduced material waste through optimized design and multi-functionality
6. Improved supply chain efficiency through more secure stacking and color-coding

By incorporating these alternatives, the paper bottle system may better address the diverse needs of pharmaceutical packaging while maintaining its core benefits of sustainability and efficient shipping.

### Aspects

The following disclose various Aspects of the present disclosure. The various Aspects are not to be construed as patent claims unless the language of the Aspect appears as a patent claim. The Aspects describe various non-limiting embodiments of the present disclosure.

Aspect 1. A paper bottle system for pharmaceuticals, comprising:
a first frustum shape conical section formed essentially of heavy-weight paper, said conical section having a flat enclosed bottom section and an open top section;
a second frustum shaped conical section fitted within the upper inside surface of said first conical section, said second conical section formed essentially of heavy-weight paper, said second conical section being open at both an upper end section and a lower end section;
a lid for sealing the top section of said second conical section formed from a biodegradable material and shaped to form an enclosed container;
an aqueous solution coated on at least the inner surfaces of said first conical section and said second conical section.

Aspect 2. The paper bottle system of Aspect 1, wherein said angle of said first conical section and said second conical section may be angled between 5-8 degrees from vertical.

Aspect 3. The paper bottle system of Aspect 1, wherein said first conical section and said second conical section may be friction fitted together.

Aspect 4. The paper bottle system of Aspect 1, wherein said first conical section and said second conical section may be adhesively joined together.

Aspect 5. The paper bottle system of Aspect 1, wherein said second conical section may be formed from a heavier weight biodegradable material than said first conical section.

Aspect 6. The paper bottle system of Aspect 1, wherein said lid may be friction fitted to said paper bottle.

Aspect 7. The paper bottle system of Aspect 1, wherein said lid may be screw locked to said bottle.

Aspect 8. A paper bottle system for pharmaceuticals, comprising:
a first frustum shape conical section formed essentially of heavy-weight paper, said conical section having a flat enclosed bottom section and an open top section;
a second frustum shaped conical section fitted within the upper inside surface of said first conical section, said second conical section formed essentially of cornstarch, said second conical section being open at both an upper end section and a lower end section;
a lid for sealing the top section of said second conical section formed from a biodegradable material and shaped to form an enclosed container; and
an aqueous solution coated on the inner surfaces of said first conical section and said second conical section.

Aspect 9. The paper bottle system of Aspect 8, wherein said angle of said first conical section and said second conical section may be angled between 5-8 degrees from vertical.

Aspect 10. The paper bottle system of Aspect 8, wherein said first conical section and said second conical section may be friction fitted together.

Aspect 11. The paper bottle system of Aspect 8, wherein said first conical section and said second conical section may be adhesively joined together.

Aspect 12. The paper bottle system of Aspect 8, wherein said second conical section may be formed from a heavier weight biodegradable material than said first conical section.

Aspect 13. The paper bottle system of Aspect 8, wherein said lid may be friction fitted to said paper bottle.

Aspect 14. The paper bottle system of Aspect 8, wherein said lid may be screw locked to said bottle.

Aspect 15. A paper bottle system for pharmaceuticals, comprising:
a first frustum shape conical section formed essentially of heavy weight paper, said conical section having a flat enclosed bottom section and an open top section;
a second frustum shaped conical section fitted within the upper inside surface of said first conical section, said second conical section formed essentially of cornstarch, said second conical section being open at both an upper end section and a lower end section;
a lid for sealing the top section of said second conical section formed from a biodegradable material and shaped to form an enclosed container;
an aqueous solution coated on at least the outer surfaces of said first conical section and said second conical section, wherein said angle of said first conical section and said second conical section may be angled between 5-8 degrees from vertical.

Aspect 16. The paper bottle system of Aspect 15, wherein said first conical section and said second conical section may be friction fitted together.

Aspect 17. The paper bottle system of Aspect 15, wherein said first conical section and said second conical section may be adhesively joined together.

Aspect 18. The paper bottle system of Aspect 15, wherein said second conical section may be formed from a heavier weight biodegradable material than said first conical section.

Aspect 19. The paper bottle system of Aspect 15, wherein said lid may be friction fitted to said paper bottle.

Aspect 20. The paper bottle system of Aspect 15, wherein said lid may be screw locked to said bottle.

The paper bottle system may provide a sustainable and biodegradable alternative to conventional plastic medication bottles. The system may include a first conical section formed from heavy-weight paper and a second conical section fitted within the upper portion of the first section. The second section may be formed from a biodegradable material such as cornstarch.

An aqueous coating may be applied to the inner and/or outer surfaces of the conical sections to improve performance without introducing plastic. The coating may help control permeability of the paper. The conical shape of the sections may allow for efficient nesting and stacking of multiple bottles. The angle of the conical sections may be between 5-8 degrees from vertical to facilitate separation when nested. The lid may be formed from a biodegradable material and may be friction fitted or screw locked to the bottle. Child-resistant options may be incorporated into the lid design. The components may be joined through friction fitting, adhesive bonding, or a combination thereof. The second conical section may be formed from a heavier weight material than the first section to provide additional strength at the bottle opening.

When disposed of, the paper bottle may biodegrade quickly, contributing to soil health rather than persisting as plastic waste. The system may provide a strong and secure container for medication while offering environmental benefits compared to conventional plastic bottles.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

Within the scope of the preferred embodiment, the paper containers may be manufactured for non-medication uses, wherever a small form factor of sustainable bottles may be of use. While the preferred embodiments of the invention have been described above, it will be recognized and understood that various modifications can be made in the invention and the appended claims are intended to cover all such modifications which may fall within the spirit and scope of the invention.

What is claimed is:

1. A paper bottle system for pharmaceuticals, comprising:
a first frustum shape conical section formed essentially of heavy-weight paper, said conical section having a flat enclosed bottom section and an open top section;
a second frustum shaped conical section fitted within the upper inside surface of said first conical section, said second conical section formed essentially of a biodegradable material, said second conical section being open at both an upper end section and a lower end section;
a lid for sealing the top section of said second conical section formed from a biodegradable material and shaped to form an enclosed container;
an aqueous solution coated on at least the inner surfaces of said first conical section and said second conical section.

2. The paper bottle system of claim 1, wherein said angle of said first conical section and said second conical section are angled between 5-8 degrees from vertical.

3. The paper bottle system of claim 1, wherein said first conical section and said second conical section are friction fitted together.

4. The paper bottle system of claim 1, wherein said first conical section and said second conical section are adhesively joined together.

5. The paper bottle system of claim 1, wherein said second conical section is formed from a heavier weight biodegradable material than said first conical section.

6. The paper bottle system of claim 1, wherein said lid is friction fitted to said paper bottle.

7. The paper bottle system of claim 1, wherein said lid is screw locked to said bottle.

8. A paper bottle system for pharmaceuticals, comprising:
a first frustum shape conical section formed essentially of heavy-weight paper, said conical section having a flat enclosed bottom section and an open top section;
a second frustum shaped conical section fitted within the upper inside surface of said first conical section, said second conical section formed essentially of cornstarch, said second conical section being open at both an upper end section and a lower end section;
a lid for sealing the top section of said second conical section formed from a biodegradable material and shaped to form an enclosed container; and
an aqueous solution coated on the inner surfaces of said first conical section and said second conical section.

9. The paper bottle system of claim 8, wherein said angle of said first conical section and said second conical section are angled between 5-8 degrees from vertical.

10. The paper bottle system of claim 8, wherein said first conical section and said second conical section are friction fitted together.

11. The paper bottle system of claim 8, wherein said first conical section and said second conical section are adhesively joined together.

12. The paper bottle system of claim 8, wherein said second conical section is formed from a heavier weight biodegradable material than said first conical section.

13. The paper bottle system of claim 8, wherein said lid is friction fitted to said paper bottle.

14. The paper bottle system of claim 8, wherein said lid is screw locked to said bottle.

15. A paper bottle system for pharmaceuticals, comprising:
a first frustum shape conical section formed essentially of heavy-weight paper, said conical section having a flat enclosed bottom section and an open top section;
a second frustum shaped conical section fitted within the upper inside surface of said first conical section, said second conical section formed essentially of cornstarch, said second conical section being open at both an upper end section and a lower end section;
a lid for sealing the top section of said second conical section formed from a biodegradable material and shaped to form an enclosed container;
an aqueous solution coated on at least the outer surfaces of said first conical section and said second conical section, wherein said angle of said first conical section and said second conical section are angled between 5-8 degrees from vertical.

16. The paper bottle system of claim 15, wherein said first conical section and said second conical section are friction fitted together.

17. The paper bottle system of claim 15, wherein said first conical section and said second conical section are adhesively joined together.

18. The paper bottle system of claim 15, wherein said second conical section is formed from a heavier weight biodegradable material than said first conical section.

19. The paper bottle system of claim 15, wherein said lid is friction fitted to said paper bottle.

20. The paper bottle system of claim 15, wherein said lid is screw locked to said bottle.
